(19) United States
(12) Patent Application Publication
(10) Pub. No.: US 2021/0129548 A1
(43) Pub. Date: May 6, 2021

(54) CONTAINER FOR FLUID

(71) Applicant: HEWLETT-PACKARD DEVELOPMENT COMPANY, L.P., Spring, TX (US)

(72) Inventors: Kevin Rourke, Leixlip, Co. Kildare (IE); John Rossi, Vancouver, WA (US); Erick Blane Kinas, Vancouver, WA (US); James Mannion, Co. Kildare (IE); Wai Kwan Chan, San Diego, CA (US)

(21) Appl. No.: 16/605,020

(22) PCT Filed: Oct. 18, 2017
(86) PCT No.: PCT/US2017/057165

§ 371 Date: Oct. 14, 2019

(51) Int. Cl. B41J 2/175

(52) U.S. Cl. CPC B41J 2/17566; B41J 2002/17579; B41J 2002/17583; B41J 2/17513

(57) ABSTRACT

A replaceable print component is disclosed that comprises first and second electrodes, and a circuit electrically connected between the first and second electrodes to vary an electrical property of the circuit with a frequency component within a selected frequency range to indicate a parameter of a part of the circuit in response to a stimulus.

### BACKGROUND

Electrical circuits may be used to detect the presence or level of a liquid in a container. The electrical circuits may include circuit components that measure the presence or level of liquid, and other parts such as connectors, wires and traces that enable electrical connection to the circuit components.

### BRIEF DESCRIPTION OF THE DRAWINGS

Non-limiting examples will now be described with reference to the accompanying drawings, in which:

FIG. 1 is a schematic drawing of an example of a replaceable print component;

FIG. 2 is an example of a frequency domain graph;

FIG. 3 is a schematic drawing of an example of a replaceable print component;

FIG. 4 is a schematic drawing of an example of a printing apparatus;

FIG. 5 is a schematic drawing of an example of a replaceable print component;

FIG. 6 is a schematic drawing of an example of a replaceable print component and printing apparatus;

FIG. 7 is an example of a frequency domain graph;

FIG. 8 is a flowchart of an example of a method of generating a signal;

FIG. 9 is a flowchart of an example of a method of generating a signal; and

FIG. 10 is a schematic drawing of an example of a vessel for fluid.

### DETAILED DESCRIPTION

In some examples, a replaceable print component comprises first and second electrodes, and a circuit electrically connected between the first and second electrodes to vary an electrical property of the circuit with a frequency component within a selected frequency range to indicate a parameter of a part of the circuit in response to a stimulus.

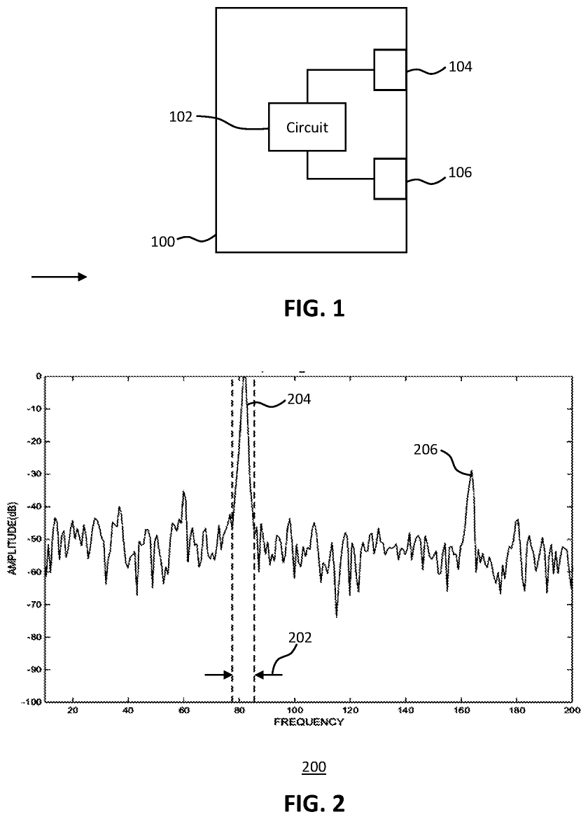

FIG. 1 is a schematic drawing of an example replaceable print component 100 that includes a circuit 102 electrically connected between electrodes 104 and 106. The electrodes may enable electrical connection to an apparatus such as a printing apparatus in which the replaceable print component 100 may be installed. The circuit 102 is to vary an electrical property of the circuit with a frequency component within a selected frequency range to indicate a parameter of a part of the circuit in response to a stimulus. For example, circuit 102 may be to output a signal having a frequency component within a selected frequency range to indicate a parameter of a part of the circuit in response to a stimulus.

In some examples, the parameter is indicative of an amount of fluid within a print agent container. For example, the parameter may indicate whether the part of the circuit is in contact with print agent within the print agent container. This may then indicate whether the print agent is above or below a certain level within the print agent container. In some examples, the electrical property may be the capacitance of the circuit 102 or of part of the circuit 102.

FIG. 2 is an example of a frequency domain graph 200 of an electrical property of circuit 102, for example using samples of the electrical property over a predetermined time period. In some examples, the frequency domain graph 200 or another suitable frequency domain representation of the electrical property may be obtained using a Fourier transform of the electrical property over time, or of samples of the electrical property. The electrical property may include, for example, a capacitance of the circuit 102 or part of the circuit 102.

The selected frequency range 202 in this example is 77-85 Hz, though this is merely an example and other frequency ranges are possible. The graph 200 shows a peak at around 81 Hz, within the selected frequency range. A lower peak 206 at the second harmonic at around 162 Hz can also be seen, though this may not be present in some examples.

The presence of the peak 204 within the selected frequency range may in some examples be indicative of a parameter of part of the circuit 102. For example, the presence of the peak 204 may indicate that the part of the circuit is not in contact with print agent within a print agent container, and hence the level of print agent is below a predetermined level at which the part of the circuit will contact the print agent. In such cases, the absence of the peak 204 may indicate that the part of the circuit is in contact with the print agent and hence the level of print agent is above the predetermined level.

In some examples, the stimulus applied to the replaceable print component 100 may be a step change in movement speed of the replaceable print component 100, such as for example a sudden acceleration or deceleration of the replaceable print component to a predetermined speed or rest. This may be achieved for example by a print apparatus in which the replaceable print component 100 is installed moving a part of the apparatus, such as for example a carriage carrying the replaceable print component 100. In some examples, the part of the circuit may comprise a flexible member that vibrates at a natural or resonant frequency in response to the stimulus, and the natural or resonant frequency is within the selected frequency range.

In some examples, the stimulus may be a cyclic or oscillatory movement of the replaceable print component. For example, this may be achieved by a print apparatus in which the replaceable print component 100 is installed moving a part of the apparatus, such as for example a carriage carrying the replaceable print component 100, in a cyclic, oscillatory or back-and-forth manner at an oscillation frequency. This may cause print agent within a container associated with the replaceable print component 100 to slosh back and forth at the oscillation frequency, and the variation of the electrical property of the circuit 102 may include a frequency component at the oscillation frequency or within a selected range around the oscillation frequency. In some examples, the frequency component, such as for example a peak 204 in a frequency domain representation of the electrical property over a period of time, may be present because the part of the circuit is in contact with print agent within the container, as the sloshing of the print agent causes the part of the circuit to move at or around the oscillation frequency, and hence the level of print agent is above a predetermined level at which the part of the circuit will contact the print agent. However, in some cases the frequency component may still be present even if the level of print agent is low enough that it does not contact the part of the circuit, even when the ink is sloshing. Therefore, the cyclic and oscillatory movement can in some examples be used to detect the presence and/or correct operation of the circuit by detection of the frequency component at the oscillation frequency. In some examples, the oscillation frequency may be selected to be different to the natural or resonant frequency of the part of the circuit, where for example the part of the circuit comprises a flexible member, such that a different frequency response may be obtained due to a step change in movement speed or an oscillatory movement.

In some examples, the circuit is to vary an electrical property of the circuit with a further frequency component within a further selected frequency range to indicate a further parameter of a further part of the circuit in response to the stimulus. Therefore, multiple parameters may be monitored or measured. For example, the variation of the electrical property may indicate whether the further part is in contact with print agent within a container, and hence may indicate whether the print agent is above or below a further predetermined level. If the part and the further part are arranged in some examples at different levels within the container, the parameter and the further parameter may indicate whether the print agent is above or below different predetermined levels within the container.

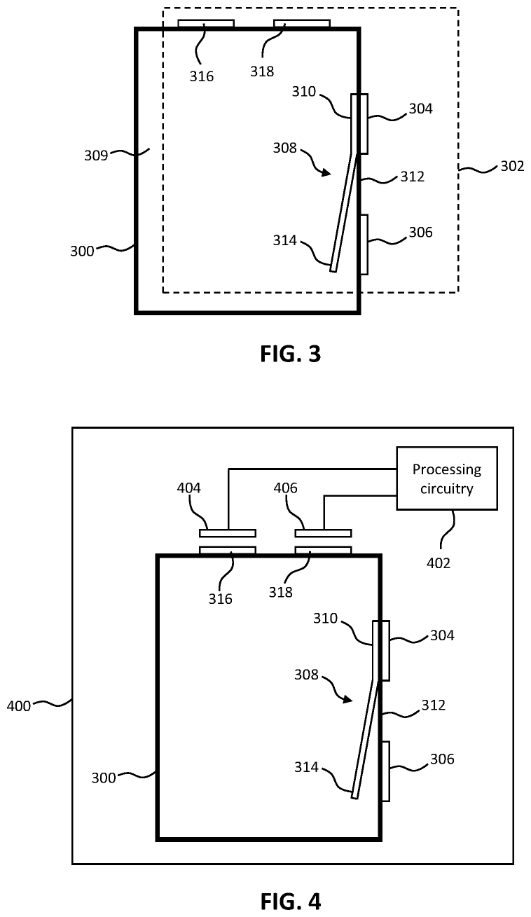

FIG. 3 a schematic drawing of an example replaceable print component 300 that includes a circuit 302. The circuit 302 includes a first electrically conductive portion 304 and a second electrically conductive portion 306. The circuit 302 also includes an electrically conductive part 308, such as for example a metal part, that is capacitively coupled to the first 304 and second 306 electrically conductive portions. The replaceable print component includes a container 309 to contain print agent. The electrically conductive part 308 is located within the print agent container 309 such that it may contact the print agent within the container 309 when the level of print agent is above a predetermined level and when the replaceable print component 300 is in its normal operating orientation.

The electrically conductive part 308 comprises a first portion 310 that is fixed to the replaceable print component 300, such as for example to a wall 312 of the replaceable print component 300. The component 308 also includes a free portion 314 that is connected to the fixed portion 310 but is free to vibrate within the replaceable print component 300. To facilitate this, the part 308 may include a flexible portion. In some examples, the component is a monolithic component comprised of a flexible material such as an electrically conductive material, for example metal.

The fixed portion 310 of the electrically conductive part 308 is capacitively coupled to the first electrically conductive portion 304 through the wall 312 of the print agent replaceable print component 300. That is, for example, the fixed portion 310 and the first electrically conductive portion 304 comprise plates of a capacitor. The capacitance of this capacitor is fixed in this example.

The free portion 314 of the electrically conductive part 308 is also capacitively coupled to the second electrically conductive portion 306 through the wall 312 of the print agent replaceable print component 300. Therefore, for example, the free portion 314 and the second electrically conductive portion 306 form the plates of an additional capacitor. As the free portion 314 of the part 308 is free to vibrate, the capacitance of the additional capacitor is variable. Furthermore, as the part 308 is electrically conductive, the capacitor formed from the fixed portion 310 and the first electrically conductive portion 304 and the capacitor formed from the free portion 214 and the second electrically conductive portion 306 are electrically arranged in series.

In some examples, a vibration characteristic of the part 308 is indicative of a parameter of the part 308 of the circuit 302, such as for example whether the free portion 314 of the part 308 is immersed in print agent within the replaceable print component 300. In some examples, vibration of the part 308 may be induced, for example through stimulus such as movement of the replaceable print component 300 or through magnetic attraction or repulsion of the part 308, and the capacitance of the circuit 302 monitored over time to monitor a vibration characteristic of the part 308. Thus, the electrical property of the circuit 302 may comprise a variable capacitance in some examples.

In some examples, the electrical property may vary in response to a stimulus applied to the replaceable print component 300. For example, the stimulus may cause a part of the circuit 302, such as the part 308, to vibrate. In some examples, the stimulus may be an impulse, or sudden force, that is applied by causing the vessel to rapidly decelerate, for example by stopping a carriage housing the replaceable print component 300 suddenly, or by causing the carriage to knock against a stopping member. The stimulus may be, for example, a step change in movement speed of the replaceable print component 300. In some examples, an external device, such as an electromagnet, may be used to generate an impulse force by generating a magnetic field to act on the circuit (e.g. on the part 308), then remove the magnetic field.

Another way of applying the stimulus may be to cause movement of the vessel in a cyclic or oscillatory manner at a defined frequency. In some examples, a direction of movement of the replaceable print component 300 may rapidly and repeatedly be reversed. For example, a mechanism for causing a carriage housing the replaceable print component 300 to move within a printing apparatus may cause the replaceable print component 300 to move backwards and forwards, for example along a track, at the defined frequency. Fluid, such as print agent, within the replaceable print component 300 may be caused to slosh from one side of the fluid container to an opposite side of the fluid container at the same defined frequency, as suggested above. The moving liquid may contact a part of the circuit 302 (e.g. the part 308). The capacitance of the circuit may then vary at a rate corresponding to the driving frequency, and the change in capacitance may be measured, for example by circuitry connected to the circuit 302. Thus, a frequency representation of the capacitance may include a component at the driving frequency. This may also be the case in some examples where the level of liquid is below the level at which it would contact the part of the circuit (e.g. the part 308), as movement of the replaceable print component may also cause movement of the part of the circuit and hence a variation in capacitance at the driving frequency.

In some examples, the part 308 (e.g. the free portion 314) may have a resonant vibrational frequency in the order of 10 to 100 Hz. This is within the range of frequencies that may be readily achieved using, for example, a part 308 in the form of a stainless steel flat spring with dimensions suitable for inclusion in a vessel 200 such as a replaceable print agent vessel, and detection apparatus (for example, analogue to digital converters, capacitance measurement apparatus and/or other detection apparatus) that is sensitive to this range is readily available. In addition, it may be noted that a part 308 with a higher resonant frequency may have lower displacement for the same quantity of input energy and therefore the movement of the free portion 314 (e.g. through measurement of capacitance of the circuit 302) may become more difficult to detect with increasing resonant frequency. Moreover, higher frequencies are associated with higher sampling rates in order to accurately characterise the oscillation. Higher sampling rates may in turn consume greater monitoring and processing resource. The selected frequency range may be a range around the actual resonant frequency of the part 308 to allow detection of the frequency component while allowing for variations in the actual resonant frequency due to measurement inaccuracies, electrical noise, manufacturing variations and/or any other sources of variation.

The lower end of the frequency range may be associated with the size of the part 308 (which may in turn be limited by the size of the replaceable print component 300). Thus, with different processing and/or size constraints, different frequency ranges may be appropriate.

The circuit 302 also includes first and second electrodes 316 and 318 electrically connected to the first 304 and second 306 electrically conductive portions respectively, for example using traces, metal vias or the like. The electrodes 316 and 318 are to permit communication between the circuit 302 and another apparatus, such as for example a printing apparatus in which the print agent replaceable print component 300 is installed. Therefore, the printing apparatus may communicate with the circuit 302, such as for example by measuring the capacitance of the circuit 302 in any suitable manner. Electrical connection between the electrodes 316 and 318 and the printing apparatus may be achieved for example through direct contact connections using pins or the like, or through additional capacitive connections.

The electrode 316 may be connected to the first electrically conductive portion 304 through wires, traces and/or any other suitable electrical components (not shown). Similarly, the electrode 318 may be connected to the second electrically conductive portion 306 through wires, traces and/or any other suitable electrical components (not shown). In some examples, the electrically conductive portions 304 and 306, electrodes 316 and 318 and any electrical connections there between may be formed on a medium such as an adhesive label that is fixed to an outside surface of the replaceable print component 300.

In the example print agent replaceable print component 300, the part 308 may be disposed within the interior of the replaceable print component 300, e.g. within the container 309, such that for example the part 308 may contact print agent if the print agent is above a certain amount and the replaceable print component 300 is in an intended orientation (for example, installed in a printing apparatus that is on a stable, flat surface). The capacitive connections between the part 308 and the first and second electrically conductive portions 304 and 306 respectively may be formed through the wall 312 of the replaceable print component 300 without any components penetrating the wall 312. In other examples, the capacitive connections may be made through different walls of the replaceable print component 300.

FIG. 4 is a schematic drawing of an example printing apparatus 400 in which a print agent replaceable print component 300 is installed. The printing apparatus includes processing circuitry 402 which includes electrodes 404 and 406. In the example shown, the printing apparatus 400 is capacitively coupled to the print agent replaceable print component 300. That is, the electrodes 404 and 316 form a first capacitor across an air gap therebetween, and the electrodes 406 and 318 form a second capacitor across an air gap therebetween. As such, there is no direct electrical connection between the processing circuitry 402 and the part 308. Instead, the processing circuitry 402 is connected to a plurality of series capacitances, one of which is variable and is indicative of a parameter of the print agent replaceable print component 300 (e.g. an amount of print agent in the replaceable print component 300). The processing circuitry 402 may detect the variation in the series capacitances to derive an indication of the parameter. In other examples, however, at least one of the electrodes 316 and/or 318 may be directly electrically connected to the processing circuitry 402 through contacts, pins or the like.

In some examples, the processing circuitry 402 may measure the electrical property of the circuit to determine a signal, or receive a signal from the circuit 302, and process the signal to determine an indication of a parameter of the part 308 of the circuit. The processing circuitry 402 may also cause a stimulus such as a step change in speed or cyclic or oscillatory movement to be applied to the replaceable print component 300.

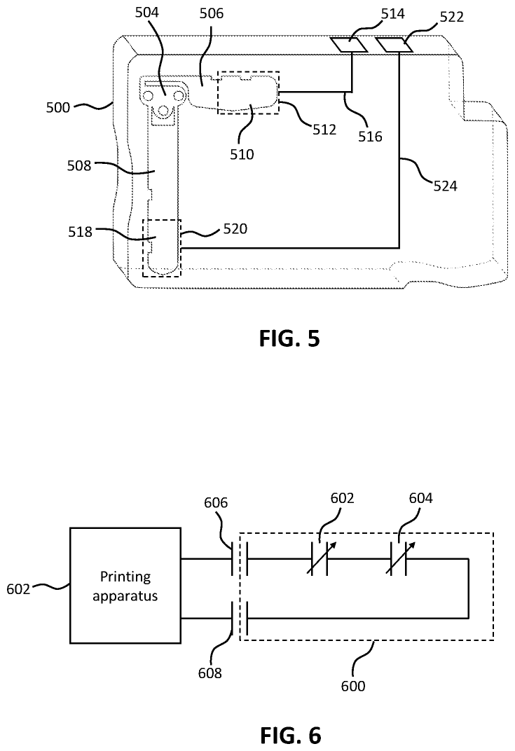

FIG. 5 is a schematic drawing of an example replaceable print component 500 that may contain fluid such as for example print agent. The replaceable print component 500 includes an electrically conductive component 502 that is mounted to an interior of the replaceable print component 500 at a mount point 504. The component 502 includes a first flexible arm 506 and a second flexible arm 508 that are free to move or vibrate about the mount point 504. A portion 510 of the first arm 506 forms one plate of a first capacitor, the other plate of the first capacitor being formed by an electrically conductive portion 512 that is fixed relative to the replaceable print component 500 and is spaced apart from the portion 510 of the first arm 506. For example, the electrically conductive portion 512 is fixed to a wall of the replaceable print component 500 or is mounted on a medium fixed to the replaceable print component 500 such as an adhesive label. The electrically conductive portion 512 is connected to a first terminal 514 via a first trace 516.

Similarly, a portion 518 of the second arm 508 forms one plate of a second capacitor, the other plate of the second capacitor being formed by an electrically conductive portion 520 that is fixed relative to the replaceable print component 500 and is spaced apart from the portion 518 of the second arm 508. For example, the electrically conductive portion 520 is fixed to a wall of the replaceable print component 500 or is mounted on a medium fixed to the replaceable print component 500 such as an adhesive label. The electrically conductive portion 520 is connected to a second terminal 522 via a first trace 524. The arms 506 and 508 may be mounted in an interior of the replaceable print component 500, for example on one side of a wall of the replaceable print component 500, and the electrically conductive portions 512 and 520 may in some examples be mounted outside of the interior, such as on an opposite side of the wall of the container. The electrically conductive portions 512 and 520 are shown as dashed outlines for clarity.

In some examples, the electrically conductive portions 512 and 520, the terminals 514 and 522 and the traces 516 and 524 are formed on a medium, such as for example an adhesive label, which is then fixed to an outside surface of the replaceable print component 500.

The replaceable print component 500 therefore includes two variable capacitors connected in series between the terminals 514 and 522, each variable capacitor being responsive to a property of the device, such as for example a level or an amount of fluid within the container 400. In the orientation shown in FIG. 5, as for example a level of print agent within the replaceable print component 500 drops, the first arm 506 of the component 502 will be exposed (i.e. no longer contact the print agent) before the second arm 508, and therefore a movement characteristic, such as for example a vibration frequency and/or decay, may indicate the level of print agent in the replaceable print component 500. Monitoring the capacitance between the terminals 514 and 522 may obtain an indication of the parameter of the replaceable print component 500. In some examples, the resonant frequency of the first arm 506 may be different to the resonant frequency of the second arm 508, and so frequency analysis of the variation in capacitance over time between the terminals 514 and 522 may indicate which of the arms 506 and 508 is vibrating and/or their decay rates, and hence a level of print agent within the container may be determined. For example, a capacitance associated with the first arm 506 may indicate a first parameter, such as whether print agent has fallen below a first level, and a capacitance associated with the second arm 508 may indicate a second parameter such as whether print agent has fallen below a second level.

FIG. 6 is a schematic drawing of an example replaceable print component 600 for fluid, for example print agent, when connected to printing apparatus 602 using contactless, capacitive connections. The container 600 includes two series connected variable capacitances 602 and 604 indicative of respective parameters of the container 600, such as for example whether a fluid level within the container 600 has fallen below respective levels. The capacitances are connected in series with and between fixed capacitors 606 and 608 which represent the capacitances of the contactless connections between the container 600 and the printing apparatus 602. Similar to as described hereinbefore, monitoring the capacitance of the series capacitances 602, 604, 606 and 608 may be indicative of one or more parameters of the container 600. The container 600 and printing apparatus 602 shown in FIG. 6 may in some examples include further components (not shown) including further electrical components. In other examples, where one or both connections between the replaceable print component 600 and the printing apparatus is a direct contact or other type of connection, the capacitance 606 and/or the capacitance 608 may not be present.

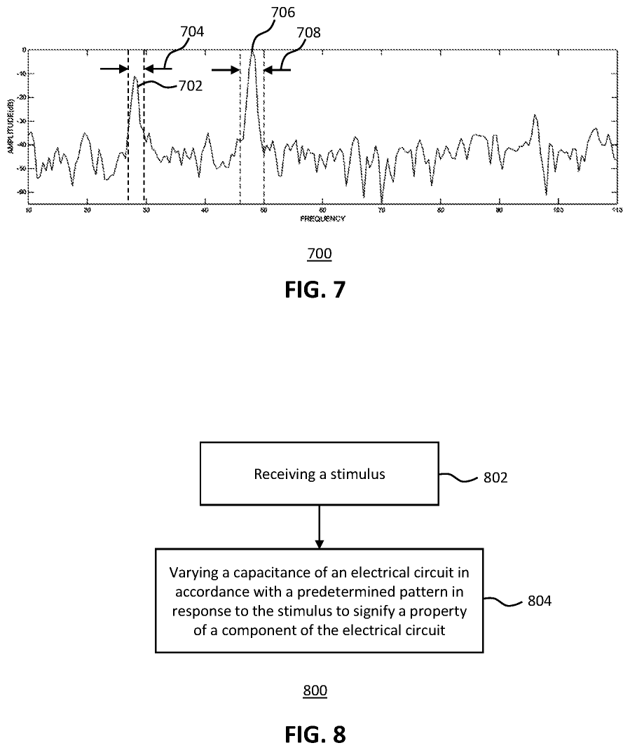

FIG. 7 is an example of a frequency domain graph 700 of measurements of an electrical property of a replaceable print component, where the electrical property varies with a frequency component 702 within a selected frequency range 704 and a further frequency component 706 within a further selected frequency range 708, to indicate respective parameters of respective parts of a circuit in response to a stimulus. For example, the frequency domain graph may be generated using samples of a signal from the circuit, or measurements of the electrical property, over a predetermined time period. In some examples, the frequency domain graph 700 or another suitable frequency domain representation may be obtained using a Fourier transform of the signal or the measurements.

The selected frequency range 704 in this example is 26-29 Hz, and the further selected frequency range 708 is 46-50 Hz, though these are merely examples and other frequency ranges are possible. The graph 700 shows a peak 702 at around 27 Hz, and a peak 706 at around 48 Hz. These may be indicative of respective parameters. For example, the peak 702 may be indicative of a parameter of a first part of a circuit, and the peak 706 may be indicative of a parameter of a second part of the circuit.

In some examples, the parameter of the first part of the circuit may be whether the first part of the circuit is in contact with print agent within a container, and the parameter of the second part of the circuit may be whether the second part of the circuit is in contact with the print agent within the container. The first and second parts may be distributed such that the associated frequency components (e.g. peaks 702 and 706 in the frequency domain) appear when the level of print agent within the container fall below different respective levels. The parts of the circuit may in some examples comprise flexible electrically conductive members that vibrate at different respective natural frequencies, such as for example 27 Hz and 48 Hz in the example shown in FIG. 7.

In some examples, the stimulus that caused the circuit to vary the electrical property in a manner having the characteristics as shown in FIG. 7 may be a step change in movement speed of the replaceable print component, causing the parts of the circuit to vibrate at their natural frequencies when not in contact with print agent within a container. Therefore, for example, the presence of the peaks 702 and 706 may indicate that the print agent level is below first and second predetermined levels. The presence of one peak (702 or 704, depending on the arrangement of the parts of the circuit within the replaceable print component) may indicate that the print agent level is above the second predetermined level and below the first predetermined level, and if neither peak is present this may indicate that the print agent level is above both first and second predetermined levels. In some examples, if the stimulus is cyclic or oscillatory movement of the replaceable print component, the movement may result in a single frequency peak in the frequency domain as one or both parts of the circuit are caused to move at the oscillation frequency. This may occur through contact with the print agent (e.g. print agent sloshing) or through movement of one or both parts of the circuit if the print agent level is low enough to not contact one or both parts when sloshing.

In some examples, the natural or resonant frequency of a part of a circuit within a replaceable print component may be chosen such that it is not at or near a typical power supply frequency, such as 50 Hz or 60 Hz, to avoid a peak resulting from power supply interference to contaminate a signal from or measurements of an electrical property of the circuit with a frequency component within a selected frequency range. This may therefore avoid incorrect interpretation of a parameter of the circuit through contamination at the power supply frequency. Additionally or alternatively, where the circuit includes multiple parts and the variation of the electrical property includes multiple frequency components indicative of multiple parameters, each of the multiple frequency components may be chosen so as to be different to other frequency and also different to second (and in some examples higher) harmonics of other frequency components. Thus, frequency analysis of the variation of the electrical property may determine the presence of the frequency components individually.

A signal output from the circuit or measurements of the electrical property (e.g. capacitance) of the circuit may include noise. Therefore, in some examples, detection of a peak in the frequency domain may take noise into account. For example, detection of a peak may include determining a noise floor as the average of the signal amplitude at each frequency across a frequency range of interest, and detecting peaks that are a certain level above the noise floor. In FIG. 2, for example, the frequency range of interest is shown as being 10-200 Hz and the noise floor is approximately −53 dB, and in FIG. 7 the frequency range of interest is 10-110 Hz and the noise floor is approximately −45 dB. Detection of a peak may then detect peaks that have a particular amplitude above the noise floor, for example at least 25 dB above the noise floor. In FIGS. 2 and 7, the Y-axis representing amplitude is chosen such that the highest amplitude is at 0 dB, though other representations are possible. Hence, in FIG. 7 for example the noise floor is at around −45 dB below the peak amplitude, the peak 706 is 45 dB above the noise floor, and the peak 702 is at −12 dB and thus 33 dB above the noise floor.

In one example, once stimulus has been applied to the replaceable print component, measurements of the electrical property (e.g. capacitance) or samples of a signal output from the circuit are taken at a rate of 1008 Hz over a predetermined time period, such as one second. The resulting samples are frequency analysed, such as a Fourier transform taken of the samples and peaks detected, to determine one or more parameters of one or more parts of the circuit. In some examples, a window function such as a Hann window or Hamming window may be applied to the samples before the Fourier transform.

FIG. 8 is a flowchart of an example of a method 800, for example a method of generating a signal, that may be carried out by for example a replaceable print component or a print agent vessel. The method 800 comprises, in block 802, receiving a stimulus. The stimulus may for example be movement of a replaceable print component carrying out the method, such as a step change in speed or cyclic or oscillatory movement. The method 800 also comprises, in block 804, varying a capacitance of an electrical circuit in accordance with a predetermined pattern in response to the stimulus to signify a property of a component of the electrical circuit. For example, the property comprises whether the component of the electrical circuit is in contact with fluid within a fluid vessel. The predetermined pattern may be in some examples a signal that has one or more frequency components at one or more predetermined frequencies or within one or more respective ranges. In some examples, the signal may be generated by varying a measurable electrical property of for example a replaceable print component or a print agent vessel. In some examples, the property (e.g. characteristic, parameter) may be indicative of the presence or absence of the circuit or part of the circuit, and/or the correct operation of the circuit or part of the circuit.

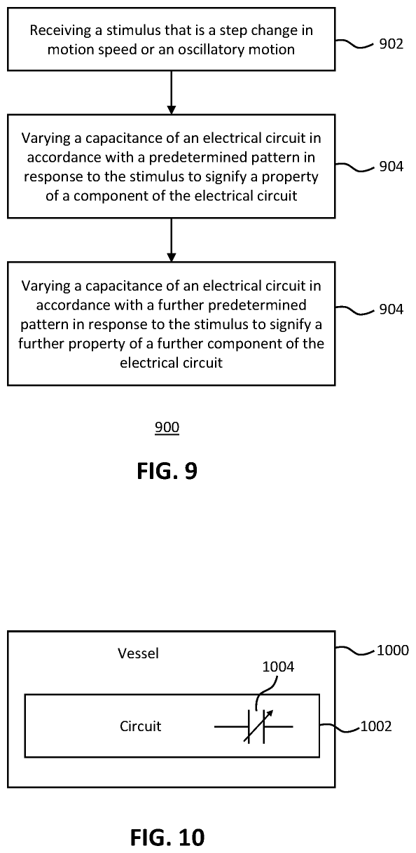

FIG. 9 is a flowchart of an example of a method 900, for example a method of generating a signal, that may be carried out by for example a replaceable print component or a print agent vessel. The method 900 comprises, in block 902, receiving a stimulus that is a step change in motion speed or an oscillatory motion. Block 904 of the method 900 comprises varying a capacitance of an electrical circuit in accordance with a predetermined pattern in response to the stimulus to signify a property of a component of the electrical circuit. This may in some examples comprise varying the capacitance of the electrical circuit to include a frequency component within a selected range. Block 906 of the method comprises varying a capacitance of an electrical circuit in accordance with a further predetermined pattern in response to the stimulus to signify a further property of a further component of the electrical circuit. This may in some examples comprise varying the capacitance of the electrical circuit to include a further frequency component within a further selected range.

FIG. 10 is a schematic drawing of an example of a replaceable print component 3000 for fluid. The vessel comprises a circuit 1002 having a measurable capacitance 1004. The capacitance of the circuit 1002 varies in a predetermined manner to indicate a characteristic of the vessel in response to movement of the vessel. For example, the capacitance of the circuit may vary such that it includes a frequency component within a predetermined frequency range. In some examples, movement of the vessel comprises cyclic or oscillatory movement of the vessel at an oscillation frequency within the predetermined frequency range. In some examples, movement of the vessel may comprise a sudden (e.g. step) change in movement speed of the vessel. The characteristic of the vessel may be in some examples an amount of fluid within an interior of the vessel, for example whether the amount of fluid within the interior of the vessel is above or below a certain amount.

In some examples described above, multiple capacitances are arranged in series. However, in some examples at least some of the capacitances may instead be arranged in parallel. For example, in some examples including two variable capacitances each corresponding to respective components or parts of a component such as a flexible arm, the variable capacitances may be arranged in an electrically parallel configuration.

Some examples described above include one or two variable capacitances within a replaceable print component or a print agent container or vessel for fluid. In other examples, there may be more variable capacitances, each of which can be indicative of for example whether an amount of fluid or print agent is above or below a respective level. For example, variation of each of the capacitances to include a frequency component at a respective frequency or within a respective frequency range may indicate whether the fluid or print agent amount is above or below the respective level.

While the apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A replaceable print component comprising:
first and second electrodes; and
a circuit electrically connected between the first and second electrodes to vary an electrical property of the circuit with a frequency component within a selected frequency range to indicate a parameter of a part of the circuit in response to a stimulus.

2. The replaceable print component of claim 1, comprising a print agent container, wherein the parameter comprises an amount of print agent in the print agent container.

3. The replaceable print component of claim 2, wherein the part of the circuit comprises an electrically conductive member, and the parameter comprises whether the electrically conductive member is in contact with the print agent in the print agent container.

4. The replaceable print component of claim 1, wherein the circuit is to vary the electrical property of the circuit with a further frequency component within a further selected frequency range to indicate a further parameter of a further part of the circuit in response to the stimulus.

5. The replaceable print component of claim 1, wherein the stimulus comprises a step change in movement speed of the replaceable print component.

6. The replaceable print component of claim 5, wherein the circuit is to vary the electrical property of the circuit with the frequency component within the selected frequency range when an amount of print agent in a print agent container is below a predetermined level, and the circuit to not vary the electrical property of the circuit with the frequency component within the selected frequency range when an amount of print agent in a print agent container is above the predetermined level.

7. The replaceable print component of claim 1, wherein the stimulus comprises an oscillatory movement of the replaceable print component at a frequency within the selected frequency range.

8. The replaceable print component of claim 1, wherein the circuit is to vary the electrical property of the circuit with the frequency component within the selected frequency range by varying a capacitance of the circuit.

9. A method comprising:
receiving a stimulus; and
varying a capacitance of an electrical circuit in accordance with a predetermined pattern in response to the stimulus to signify a property of a component of the electrical circuit.

10. The method of claim 9, wherein the property comprises whether the component of the electrical circuit is in contact with fluid within a fluid vessel.

11. The method of claim 9, comprising varying a capacitance of the electrical circuit in accordance with a further predetermined pattern in response to the stimulus to signify a further property of a component of the electrical circuit.

12. The method of claim 9, wherein receiving a stimulus comprises receiving a step change in motion speed or an oscillatory motion.

13. The method of claim 9, wherein varying a capacitance of an electrical circuit in accordance with a predetermined pattern comprises varying the capacitance to include a frequency component within a selected range.

14. A vessel for fluid, the vessel comprising:
a circuit having a measurable capacitance;
wherein the capacitance of the circuit varies in a predetermined manner to indicate a characteristic of the vessel in response to movement of the vessel.

15. The vessel of claim 14, wherein the capacitance of the circuit varies to include a frequency component at a predetermined frequency in response to the movement of the vessel to indicate the characteristic of the vessel.
